(19) United States
(12) Patent Application Publication
(10) Pub. No.: US 2006/0209507 A1
(43) Pub. Date: Sep. 21, 2006

(54) Media holding device

(76) Inventors: S. Eric Sidle, Fort Collins, CO (US); Mike Erickson, Loveland, CO (US); Raymond J. Woodward, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,590

(22) Filed: Mar. 17, 2005

(51) Int. Cl. G06F 1/16

(52) U.S. Cl. 361/685

(57) ABSTRACT

A media holding device for connecting an electronic component to a computer is described herein. An embodiment of the device comprises a bay comprising a bay first side and a bay second side, wherein the electronic component is receivable in the bay first side. The media holding device may also comprise a first circuit comprising a first connector and a second connector. The first connector is located proximate the bay second side. A third connector associated with the electronic component is connectable to the first connector when the electronic component is received within the bay. A connector associated with the computer is connectable to the second connector. The circuit translates a first data protocol transmitted by way of the first connector to a second data protocol transmitted by way of the second connector. The media holding device may further comprise a release member, wherein the release member is movable relative to the bay. The release member is in a first position when it is located in a first position relative to the bay and wherein the first release member is in a second position when it is in a second position relative to the bay. Movement of the first release member from the first position to the second position causes the first connector to disconnect from the third connector.

### BACKGROUND

Computer components and other electronic components are being manufactured much smaller than in the past. For example, many disc drives, both magnetic and optical are now able to be manufactured at half the size or less than they were in the past. These smaller components are typically used in laptop computers and other portable devices. Some of these smaller electronic components use different data transfer protocols than their predecessors.

Desktop type computers typically use the larger predecessor electronic components with data transfer protocols that have been in existence for a long time. The desktop computers have bays and electronic connectors that receive the larger electronic components. Thus, the newer electronic components are not able to be used in desktop computers. Therefore, a user of a laptop computer cannot readily remove the hard drive from the laptop computer and insert it into a desktop computer.

### BRIEF DESCRIPTION OF THE DRAWINGS

FIG. 1 is an embodiment of a computer case.

FIG. 2 is an embodiment of a top front perspective view of a media holding device that may be used with the computer case of FIG. 1.

FIG. 3 is an embodiment of a top rear perspective view of the media holding device of FIG. 2.

FIG. 4 is an embodiment of a spring and latch used to hold an electronic component within a bay of the media holding device.

FIG. 5 is a front bottom perspective view of the media holding device of FIGS. 2 and 3.

### DETAILED DESCRIPTION

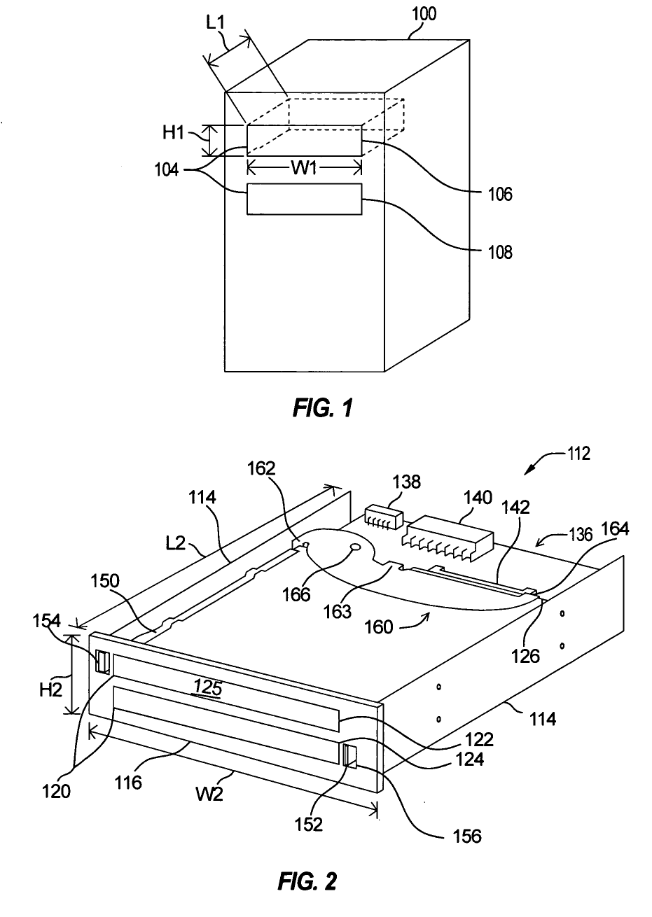

Devices for enabling different sized electronic components, such as optical and magnetic drives, to be used in computers are disclosed herein. The devices further translate data protocols used by the electronic components to those used by the computer. Referring to FIG. 1, an embodiment of a computer 100 is shown. The computer 100 may be a common computer or server. The computer 100 includes at least one bay 104. The embodiment of the computer case 100 includes a first bay 106 and a second bay 108. The bays 104 serve to receive electronic components, such as magnetic and optical drives. As described below, component holding devices may be received in the bays 104, wherein smaller electronic components are received in the component holding devices.

The bays 104 have a height H1, a width W1, and a length L1 as illustrated by the first bay 106. In one embodiment of the bays, the size of the bays are referred to as being half size or supporting a half size cage as described in greater detail below. In one embodiment, the height H1 may be approximately one and one half inches, the width W1 may be approximately five and three quarters. The bays 104 may have cages or the like, wherein electronic components and electronic component holders are receivable in the cages.

An embodiment of an electronic component holding device or simply a component holding device 112 that may be received within the bays 104 is shown in FIG. 2. The component holding device 112 may include a chassis 114 with a panel 116 attached or integral to the chassis 114. The panel 116 may include at least one sub-bay 120. In the embodiment of the component holding device 112, the panel includes a first sub-bay 122 and a second sub-bay 124. As described in greater detail below, electronic components, such as magnetic and optical drives may be inserted into the sub-bays 120, which ultimately connects the electronic components to the computer 100, FIG. 1. Each sub-bay 120 may have a front side 125 and a rear side 126. The front side 125 and rear side 126 are sometimes referred to as the first side and the second side, respectively. The front sides of the sub-bays 120 provide for entry of the electronic devices into the sub-bays 120. In some embodiments, the front sides of the sub-bays 120 may have doors or the like covering the openings into the sub-bays 120.

With additional reference to FIG. 1, and as described above, the component holding device 112 may be located within a bay 104 of the computer 100. In order for the component holding device 112 to fit into a bay 140, the panel 116 has a height H2 and a width W2 that are similar to the height H1 and width W1 of the first bay 106 or any other bay to which the component holding device 112 will be received. It is noted that the component holding device 112 has a length L2 that is not too long to be received within the bays 104.

The component holding device 112 may also include a first circuit 136. The first circuit 136 may be a circuit board and serves to electrically connect an electronic device located in a sub-bay to the computer 100, FIG. 1. The first circuit 136 may also convert a data transfer protocol used by the electronic device located in a sub-bay 120 to a protocol used by the computer 100. In the embodiment of the first circuit 136 of FIG. 2, the first circuit 136 includes three connectors, which are referred to as a power connector 138, a computer interface connector 140 and an electronic component interface connector 142, which is sometimes referred to simply as the component interface connector 142. The component interface connector 142 is sometimes referred to as the first connector and the computer interface connector 140 is sometimes referred as the second connector.

The power connector 138 serves to provide power from the computer to both the first circuit 136 and the electronic component located in a sub-bay. The computer interface connector 140 serves to connect the first circuit 136 to the computer 100. Thus, the computer interface connector 140 is adapted to connect to a data connector or the like located in the computer 100. The component interface connector 142 serves to connect the electronic device to the first circuit 136. For example, the electronic device may have a connector (sometimes referred to as the third connector) that plugs into the component interface connector 142. The component interface connector 142 may also serve to provide power from the computer 100 to the electronic device. All the sub-bays 120 may share a single circuit 136 or each sub-bay 120 may have a separate circuit associated therewith.

Each of the sub-bays 120 may have a release mechanism associated therewith. The release mechanisms are described in detail below and are used to release the electronic components located within the sub-bays 120. More specifically, a user may press the release tabs in order to disconnect electronic components located in the sub-bays and to remove the electronic components from the sub-bays. In the embodiment described herein, the first sub-bay 122 has a first release mechanism 150 associated therewith and the second sub-bay 124 has a second release mechanism 152, FIG. 5, associated therewith. Each release mechanism has a front end and a back end, which are sometimes referred to as first ends and second ends, respectively. The front end 154 of the first release mechanism 150 and the front end 156 of the second release mechanism 152 are shown in FIG. 2.

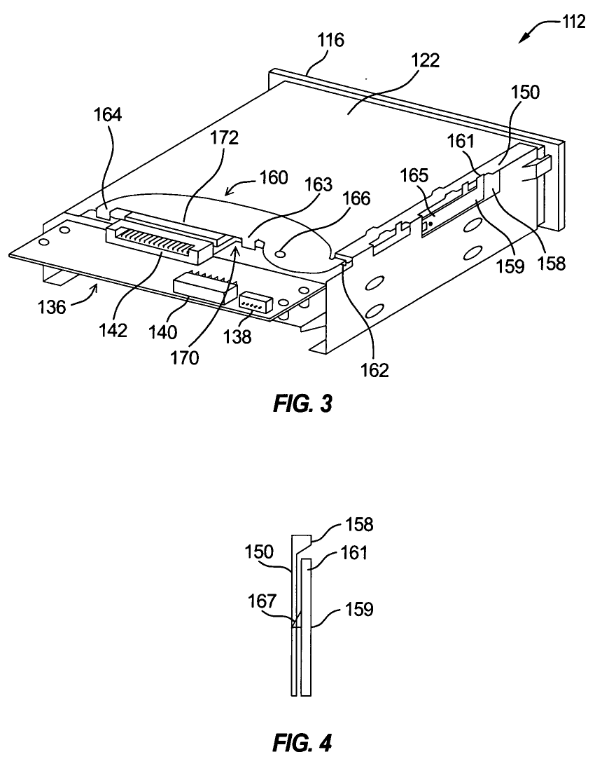

Referring to FIG. 3, it is noted that the first release mechanism 150 may extend substantially the length of the holding device 112. As described in greater detail below, the first release mechanism 150 may move toward the back of the holding device 112 when electronic components are released from the first sub-bay 122. The first release mechanism 150 has a cut out or hole 157 formed therein. A ramp 158 may be located adjacent or may be integral to the hole 157. A spring 159 is located within the hole 157. In the embodiment of FIG. 3, the spring is a flexible piece of metal. The spring 159 may be mounted to the first sub-bay 122 by way of a fastener 165, such as a rivet. The spring 159 has an end 161 that is located proximate the ramp 158.

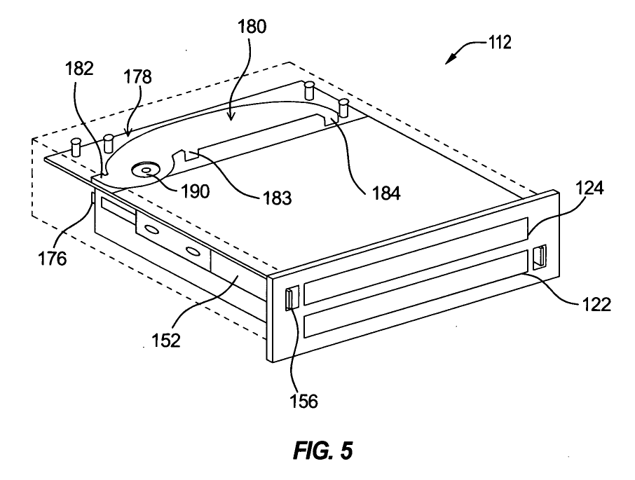

A top view of the spring 159 relative to the first release mechanism is shown in FIG. 4. The spring 159 includes a latch member 167 that extends into the bay of the holding device 112. The latch member serves to secure an electronic component within the bay. For example, the electronic component may have a notch, not shown, that receives the latch member 167. Therefore, when the electronic component is inserted into the bay, it is secured by the latch member 167. When the first release mechanism 150 moves, the ramp eventually contacts the end 161 of the spring 159, which forces the latch member 167 from the bay. When the latch member 167 is removed from the bay, the electronic component may be removed from the bay as described below.

Each of the sub-bays 120 has a release member associated therewith. A first release member 160 associated with the first sub-bay 122 is shown in FIG. 2. The first release member 160 and the other release member that are not shown in FIG. 2 have a first tab 162 and a second tab 163, and a third tab 164. As described in greater detail below, the first tab 162 is situated to be able to be contacted by the back end (not shown) of the first release mechanism 150. As also described in greater detail below, the second tab 163, and the third tab 164 are situated so as to be able to contact an electronic component (not shown) located in the first sub-bay 122. In the embodiment of the first release member 160 shown in FIG. 2, the second tab 163 and the third tab 164 are located on either side of the component interface connector 142. This location of the second tab 163 and the third tab 164 provides for release of an electronic device from the component interface connector 142 without twisting the electronic component relative to the component interface connector 142.

As shown in FIG. 2, the release members are pivotally attached within the component holding device 112. For example, the release members may be pivotally attached to the chassis 114 or a sub-bay. In the embodiment of the first release member 160 shown in FIG. 2, the first release member 160 pivots about a pivot point 166. The first pivot point 166 may be a pin or the like attached to the first sub-bay 122. Regardless of how the first release member 160 or any of the other release members are attached, their attachment enables the first tab 162 to move in an opposite direction relative to the second tab 163 and the third tab 164. Thus, when the first release mechanism 150 is pressed inward, the first tab 162 moves outward and the second tab 163 and the third tab 164 move inward. The inward movement of the second tab 163 and the third tab 164 causes an electronic component located in the first sub-bay 122 to become disconnected from the component interface connector 142 and to be slightly ejected from the first sub-bay 122. The electronic component may then be readily removed from the first sub-bay 122.

A rear perspective view of the component holding device 112 is shown in FIG. 3. An electronic component 170 is located in the first sub-bay 122. The electronic component 170 has a connector 172 (sometimes referred to as the third connector) that is situated so as to be connectable with the component interface connector 142 when the electronic component 170 is located further in the first sub-bay 122. As shown in FIG. 3, both the second tab 163 and the third tab 164 are able to contact the electronic component 170 on either side of the connector 172. Therefore, as the first release mechanism 150 is pressed toward the first tab 162, the second tab 163 and the third tab 164 engage the electronic component 170. The engagement causes the electronic component 170 to move out of the first sub-bay 122. In addition, the connector 172 is disconnected from the component interface connector 142 without twisting one connector relative to the other connector. This separation reduces the possibility of either connector being damaged during disconnect.

Having described the first sub-bay 122, the second sub-bay 124 will now be described. FIG. 5 is a front, bottom perspective view of the component holding device 112. FIG. 5 shows a portion of the chassis 114, FIG. 2, removed so as to illustrate the second release mechanism 152. The front end 156 and a rear end 176 of the second release mechanism 152 are also illustrated in FIG. 5. A second circuit 178 or second circuit board is shown in FIG. 5. The second circuit 178 is substantially similar or identical to the first circuit 136 of FIG. 3. Therefore, the second circuit 178 may include a connector similar to the electric device connector 142 of FIG. 3 that serves to connect to a connector, not shown, located on an electronic component located in the second sub-bay 124.

A second release member 180 is associated with the second sub-bay 124. In the embodiment of the component holding device 112 described herein, the second release member 180 has the same physical characteristics as the first release member 160, FIG. 3. Therefore, the cost of the component holding device 112 is reduced because substantially identical parts may be used for both release members. As shown in comparison of FIGS. 3 and 4, the two release members are mounted upside down relative to each other.

As with the first media release member 160, the second release member 180 includes a first tab 182, a second tab 183, and a third tab 184. The second tab 183 and the third tab 184 may be located on opposite sides of the above-described connector that serves to connect the second circuit 178 to the electronic component that may be in the second sub-bay 124. The second release member 180 pivots about a pivot point 190. Because the second release member 180 is mounted opposite the first release member 160 of FIG. 3, the pivot point 190 may have to be located at a slightly different location than the pivot point 166 of first release member 160, FIG. 3.

In use, an electronic component may be inserted into the second sub-bay 124. As described with regard to the first sub-bay 122, the electronic component connects to the above-described connectors that may be attached to the second circuit 178. In order to remove the electronic component from the second sub-bay 124 a user presses the front end 156 of the second release mechanism 152. The pressing causes the second rear end 176 of the second release mechanism 152 to push the first tab 182 of the second release member 180. The second release member 180 pivots about pivot point 190 and causes the second tab 183 and the third tab 184 to force the electronic component out of the second sub-bay 124.

It is noted that the circuit 178, like the circuit 136 of FIG. 2, serves to electrically interface the electronic components with the computer. For example, if the computer uses a first data protocol and the electronic components use a second data protocol, the circuits 136, 178 will translate the data from the first data protocol to the second data protocol and visa versa. Thus, electronic components using different data protocols can be used by the computer.

Having described some embodiments of the component holding device 112, other embodiments will now be described. In one embodiment, the media holding device has only one sub-bay. Such an embodiment enables an electronic component that is different than the ones used in the computer. In other embodiments, the media holding device has more than two sub-bays.

In another embodiment, the sub-bays are different sizes so as to accommodate different sized electronic components. In this embodiment the connectors that connect to the electronic components may be different. Likewise, the release members may be different so as press against the different electronic components. For example, the different electronic components may have connectors located in different locations. Therefore, the release members may have to differ from one another.

In another embodiment, the release members 160 and 180 have two tabs instead of three. With reference to FIG. 5, either the second tab 183 or the third tab 184 is removed. This embodiment may reduce the cost of the component holding device 112.

In another embodiment, the circuits 136, 178 have a plurality of connectors that are configured to connect to a plurality of different electronic components. Therefore, the sub-bays may receive different types of electronic components. In such an embodiment, the circuits 136, 178 may also be configured to convert a plurality of different data protocols used by the different electronic components to the data protocol used by the computer and visa versa.

What is claimed is:

1. A media holding device for connecting an electronic component to a computer, said device comprising:
a first bay comprising a first bay first side and a first bay second side, wherein said electronic component is receivable in said first bay first side;
a first circuit comprising a first connector and a second connector, said first connector being located proximate said first bay second side, wherein a third connector associated with said electronic component is connectable to said first connector when said electronic component is received within said first bay, wherein a connector associated with said computer is connectable to said second connector, and wherein said circuit translates a first data protocol transmitted by way of said first connector to a second data protocol transmitted by way of said second connector; and
a first release member, wherein said first release member is movable relative to said first bay, wherein said first release member is in a first position when it is located in a first position relative to said first bay and wherein said first release member is in a second position when it is in a second position relative to said first bay;
wherein movement of said first release member from said first position to said second position causes said first connector to disconnect from said third connector.

2. The device of claim 1, wherein said first release member is pivotally attached within said media holding device at a pivot point, said first release member having a first portion located on a first side of said pivot point and a second portion located on a second side of said pivot point.

3. The device of claim 2, wherein said first portion of said first release member has at least one member extending therefrom, wherein a media component located within said first bay is contactable by said at least one member.

4. The device of claim 2, wherein a first member and a second member extend from said first portion of said first release member, said first member and said second member being located adjacent opposite sides of said first connector.

5. The device of claim 2 and further comprising a release tab, said release tab comprising a first end and a second end, wherein said first end of said release tab is located proximate said first bay first side, and wherein said second end of said release tab contacts said second portion of said first release member.

6. The device of claim 1, wherein said media holding device is receivable within a computer.

7. The device of claim 1, and further comprising:
a second bay comprising a second bay first side and a second bay second side, wherein a second electronic component is receivable in said second bay first side;
a fourth connector connectable to a fifth connector associated with said second electronic component;
a second release member, wherein said second release member is movable relative to said second bay, wherein said second release member is in a first position when it is located in a first position relative to said second bay and wherein said first release member is in a second position when it is in a second position relative to said second bay;
wherein movement of said second release member from said first position to said second position causes said fourth connector to disconnect from said fifth connector.

8. The device of claim 7, wherein said first electronic component and said second electronic component are the same physical size.

9. The device of claim 7, wherein said first electronic component and said second electronic component are different physical sizes.

10. The device of claim 7, wherein said first connector and said fourth connector are located on the same circuit.

11. The device of claim 7, and further comprising a second circuit, wherein said fourth connector is located on said second circuit.

12. The device of claim 11, wherein said second circuit comprises a sixth connector that is connectable to said computer.

13. The device of claim 7, wherein said first release member and said second release member have the same physical dimensions.

14. The device of claim 7, wherein said second release member is pivotally attached within said media holding device at a pivot point, said second release member having a first portion located on a first side of said pivot point and a second portion located on a second side of said pivot point.

15. The device of claim 14, wherein said first portion of said second release member has at least one member extending therefrom, wherein said media component located within said second bay is contactable by said at least one member.

16. The device of claim 14, wherein a first member and a second member extend from said first portion of said second release member, said first member and said second member being located adjacent opposite sides of said fifth connector.

17. The device of claim 14 and further comprising a release tab, said release tab comprising a first end and a second end, wherein said first end of said release tab is located proximate said second bay first side, and wherein said second end of said release tab contacts said second portion of said second release member.

18. The device of claim 1, and further comprising a spring, said spring comprising an end and a latch, wherein said latch is locatable within said first bay, said latch having a first position when it is located within said first bay and a second position when said latch is not located within said first bay;
wherein said first release member comprises a ramp, said ramp being contactable with said spring end;
wherein said ramp does not contact said spring first end when said first release member is in said first position and said spring is in said first position; and
wherein said ramp contacts said spring first end when said first release member is moved from said first position to said second position, said contact causing said spring to move to said second position.
